(19) United States
(12) Patent Application Publication
(10) Pub. No.: US 2012/0303497 A1
(43) Pub. Date: Nov. 29, 2012

(54) LEGAL COST MANAGEMENT SYSTEM

(76) Inventor: Michael L. Derry, Bloomfield Hills, MI (US)

(21) Appl. No.: 13/482,362

(22) Filed: May 29, 2012

Related U.S. Application Data
(63) Continuation-in-part of application No. 10/517,287, filed on Dec. 8, 2004, now Pat. No. 8,214,320.
(60) Provisional application No. 60/387,666, filed on Jun. 11, 2002.

(51) Int. Cl. G06Q 50/18; G06Q 40/00; G06Q 30/04

(52) U.S. Cl. 705/34; 705/30

(57) ABSTRACT

A legal cost management system provides modules for outlining the process of a legal function, establishing pricing variables to each step of the legal function, all at the outset of the legal task. A budget is then generated and the legal task is managed by outside counsel based upon the agreed upon budget and process. When exceptions occur during the course of working on the legal function, outside counsel electronically submits requests for new work to corporate counsel, which in turn can be approved or denied. Point and click billing allows immediate invoicing which requires no review by corporate counsel as the work performed has already been approved. Statistical reporting provides corporate counsel with real time analysis of all the cases that are in the system.

### CROSS-REFERENCE TO RELATED APPLICATIONS

This application is a Continuation-in-part of application Ser. No. 10/517,287 filed on Dec. 8, 2004, which is a National Stage Application of PCT/US03/18259, which claims priority to U.S. Provisional Application 60/387,666 filed on Jun. 11, 2002.

### FIELD OF THE INVENTION

The present invention relates generally to a legal process cost control management system for use by corporate counsel that manages all types of case loads, more specifically, an interactive real time system to be used between corporate counsel and with law firms where there is a need to add efficiencies and to standardize, streamline, facilitate, and control the cost of legal services.

### BACKGROUND AND SUMMARY OF THE INVENTION

Traditionally the management of legal services, such as litigation, involves the client, corporate counsel, calling the outside counsel or law firm and informing them they have a problem that needs to be resolved. If the problem is a suit that has been filed against the company, then a firm is retained and the defense begins. Often large corporations will have massive litigation budgets established in order to defend the company in the 100's of cases that are pending at any one given time. In massive tort litigation, a company could have 100's of cases pending in different states, counties and jurisdictions. This requires multiple firms and lawyers to be retained in order to handle the cases. As a result, corporate counsel is subjected to the different management styles, the jurisdictional nuances, and the different billing and invoicing practices for each law firm.

The invoicing and billing systems for each of the law firms that corporate counsel retains may vary which results in inefficiencies for both corporate counsel and for law firms. Typically, a lawsuit begins with commencement of an action by filing a complaint, then settlement negotiations may occur, and if they are not successful, then the case proceeds. The next step involves the parties commencing discovery on one another and on non-parties. Motion practice can begin before or after discovery depending upon posturing of the parties. After motion practice is completed, the case either settles or goes to trial.

The management of this process varies from law firm to law firm, often depending on the type of suit and the skill and experience of the attorneys working on the case. The cost of the suit accordingly varies because different attorneys have different management styles. Some attorneys may prefer to use experts, some may not, some may prefer extensive motion practice, some may not, some may rely heavily on depositions, and some firms may not take any depositions at all. These varying practices lead to inconsistencies of how corporate counsel deals with the various law firms it may retain. For example, if a corporation is defending itself against mass tort litigation cases that are pending in various states around the country, then law firms in each of those states would be retained. The attorneys in each of those firms will have different hourly rates, will have different experience levels, and will vary on how long they take to draft motions, prepare for hearings and depositions, etc. This causes unpredictability for budgeting purposes, something corporations would like to overcome.

Traditionally, the invoicing and billing for litigation is done either on a fixed fee arrangement, a contingency fee arrangement, or on a pay as you go, or hourly, arrangement where invoices are generated each month, and paid. Each of these fee arrangements has drawbacks that could affect the relationship with counsel and the quality of the representation and the cost of the litigation.

Fixed fee arrangement requires the parties to establish a fixed fee amount at the outset of the case. With this type of arrangement, the work that is performed and the hours that are billed are recorded and tracked during litigation. Often, workload is adjusted based upon cost averaging. This type of fee arrangement runs the risk of being result oriented as the firm may be less inclined to be as effective if it sees the work is exceeding the time allotted in the fixed fee arrangement. Fixed fee arrangements can also result in other inefficiencies which affect the quality of the work and negatively affect the outcome of the case.

Contingency fee arrangements likewise have certain inefficiencies which may negatively affect the outcome of the case. For example, if the case continues and it is later realized that the outcome is going to bring little value, the quality of services rendered could decrease or cease all together. Other inefficiencies may occur with this arrangement resulting in a less than desirable outcome. On the other hand, if it is realized that the outcome of the case will yield abnormally high results, then the firm may realize an unfair return on their efforts to the client's dismay.

The standard pay as you go fee arrangement involves performing the work on a monthly basis and invoicing same shortly thereafter. In the traditional litigation invoicing and billing arrangement, a client would be advised as to the litigation process and, after the appropriate investigation, the case would begin. As the work is done, the time and cost are logged in on a daily basis. At the end of each month an invoice is created which summarizes the time and costs along with a description of services that were rendered. The invoice is then reviewed by the partner, corrected where necessary which requires steps back and forth with the typist, to where it is then finalized. Once finalized, the invoice generally goes through an auditing process in an accounting department of the law firm for verification with the firm's billing system.

If a firm's accounting department finds a problem, the invoice goes back to the billing attorney for correction and then goes through the system one more time. However, if the invoice passes scrutiny the first time, and is electronically sent, or is placed in an envelope, postage is applied to the envelope, and it is sealed and then forwarded to corporate counsel whose company receives it in a few days. Once the company receives the invoice, it goes to their accounting department to be logged in to the system. Thereafter, the invoice is forwarded to the corporate case manager that is in charge of that particular case, for review, critique, approval or disapproval. This requires corporate counsel to set aside the time for this step, which slows down the collection process. If the invoice does not comply with corporate counsel's billing standards, or otherwise is not acceptable, then the invoice could be rejected and possibly returned to the billing attorney for correction. Worse yet, the invoice could be put in the ‘to deal with later’ pile and it may sit for a lengthy period before being resolved. For the firm, this delay reduces cash flow, minimizes realization on the account and the entire process increases the cost of doing business for both in-house counsel and outside counsel.

However, once the invoice passes corporate counsel's review, the invoice is sent to the company's billing department for payment. In many instances payment is not even scheduled until thirty (30) days after the aforementioned process has been completed. Once the draft for paying the invoice has been cut, it too may set and then be put into an envelope, sealed, postage applied thereto, and sent off to the law firm. This requires yet additional steps by the law firm because it now has to reconcile the check with its own internal accounting system and then have the check deposited with the bank.

The aforementioned process can further be delayed if the charges billed on the invoice were not approved by corporate counsel. Worse yet, is when the work has been previously approved by corporate counsel, but the company now refuses to pay for the work after it has been completed. Thus, in the traditional litigation arrangement where the client pays as the work is done, significant steps are involved which can lead to inefficiencies, re-work disputes over billing, wasted time in the billing and invoicing process, loss of realization of time and money, and long periods before payment is ever made or received.

There are other problems with the traditional style of billing the client after the work has been. For example, controlling costs of litigation after the work has been performed, is inherently problematic. For law firms working on an hourly rate, there is little incentive in the system to be efficient. The result is that a firm may invoice for their inefficiencies and non-value added steps, which the client may not become aware of until after the work is completed and the invoice has already been sent to the client. It would be preferred to provide a litigation cost control management system that allows corporate counsel to control fees at their point of origin, that is, when the work is being performed. It would also be preferred to provide a methodology of managing the cost of litigation that controls the unit of time and the value of the activity, which would allow for automatic enforcement and compliance with the companies litigation guidelines, with little or no associated monitoring costs.

It would also be desirable to provide a litigation cost control management system that is much more than just a billing system, but instead an efficient cost control device that removes waste in the litigation process, surprises to the client, yet yields high quality legal services at predictable costs. The system allows the client to have complete control over the litigation process. The present invention accomplishes this objective through implementing cost containment and control, by accurately and continuously updating the case activity and the litigation budget through real time communications between inside counsel and outside counsel.

It would also be desirable to provide a legal cost control management system that utilizes some of the aspects of the litigation cost control management system discussed herein. The legal cost control management system would enable both a client and a law firm to create budgets based upon the specific tasks the law firm was to perform while utilizing process management methodologies to various legal practice areas. For example, the legal cost control management system may be utilized not only to manage litigation costs, but also to practice areas such as administrative and regulatory, banking and financial services, bankruptcy, restructuring and creditors' rights, construction, corporate law, corporate finance, employee benefits, environmental, energy and sustainability, estate planning administration, family and matrimonial, and other areas of the legal profession. It will be appreciated that while the discussion below primarily focuses on a litigation cost control management system, such system can be applied to other legal profession practice areas.

Another embodiment of the present invention provides a cost management system that allows for exceptions to be made during the case that can be immediately approved by the system or approved, revised or denied by the case manager, then added to the billing system with ease. Cost based decision making allows for continuous updates and allows corporate counsel to know at any given time, the cost, and status of the litigation without ever needing to pick up the phone and contact outside counsel. One aspect of the invention allows costs to be captured when the work is done, thus allowing the billing partner or other appropriate firm personnel to point and click in order to electronically invoice the client at any time. Thus, there is no need for the law firm or corporate counsel to review the invoice because the work has been previously approved.

Another embodiment of the present invention eliminates the need for corporate counsel to approve items on invoices, eliminates any up-time charges, eliminates any re-work, eliminates over billing and payments for any of the inefficiencies as a result of the firm. This is accomplished by utilizing litigation process maps that allow for task value pricing at the outset of the case in order to establish a budget.

One of the embodiments of the present invention provides a point and click invoicing system that automatically sends a current invoice to general counsel's accounting department. It would be desirable to immediately transfer the required funds from the corporation to the firm's bank account, thus eliminating several days of delays and effort. The present invention accomplishes this task because the work performed has been previously approved at the amount agreed upon, and thus, the standard inefficiencies in the system are removed.

Another embodiment of the present invention provides a cost based decision making litigation process management system that allows for capturing immediate application of the best practices of all law firms that are within the system. Yet another embodiment of the present invention allows inside counsel to be able to award bonuses to a firm that does exceptional work by allowing corporate counsel to add a variance to the predetermined budget.

Another embodiment of the present invention provides a system with changeable variances, for each task performed by the firm in order to assist in budgeting at the outset of the case. The system also accommodates projected expenses, and allows corporate counsel to approve a budget, or reject it with alternatives, and then to have the outside law firm approve the budget. One aspect of the present invention would provide for exceptions to the budget, with prior approval and would automatically update the system so that real-time data can be obtained as to the current costs of each case.

Another embodiment of the present invention provides statistical analysis of the performance of each law firm that is in the company's database.

### DESCRIPTION OF THE FIGURES

FIG. 1 is a flow chart illustrating the eight basic areas or modules of the litigation cost management system.

FIG. 2 illustrates a process map for the steps involved in responding to a complaint;

FIG. 3 illustrates the second part of the process map for responding to a complaint;

FIG. 4 illustrates a process map for preparing and filing a cross complaint;

FIG. 5 is the second part of the process map for filing a cross complaint;

FIG. 6 is a process map for preparing an affidavit;

FIG. 7 is the second part of the process map for preparing an affidavit;

FIG. 8 illustrates an output from the computer screen illustrating the default values tab selected;

FIG. 9 illustrates a screen output from the litigation cost management system, illustrating the pricing control chart ranges;

FIG. 10 illustrates a flow chart that shows the steps in-house counsel goes through when generating a new case budget;

FIG. 11 is a continuation of the steps in-house counsel goes through when developing a new case budget;

FIG. 12 is a screen printout from the litigation cost management system illustrating a budget and litigation worksheet prepared for submission to outside counsel;

FIG. 13 illustrates a screen output for outside counsel to review the budget;

FIG. 14 illustrates a screen output from the litigation cost management system from the outside counsel's viewpoint, showing changes that have been made to the budget using this screen;

FIG. 15 illustrates a screen printout from the litigation cost management system from inside counsel's perspective, showing the change request from outside counsel, prior to the budget being accepted;

FIG. 16 illustrates a screen output from the litigation cost management system from corporate counsel's perspective, illustrating some of the cases in the system;

FIG. 17 illustrates a screen output for the present invention from outside counsel's perspective, and depicting a current case budget status;

FIG. 18 illustrates a work flow diagram of the invoicing/billing system of the present invention;

FIG. 19 illustrates a work flow diagram from the outside counsel's perspective of the billing/invoicing process;

FIG. 20 is a screen outside counsel sees when beginning the point and click billing process;

FIG. 21 is another screen outside counsel sees when billing a particular task;

FIG. 22 is the screen outside counsel sees in order to submit an invoice to corporate counsel;

FIG. 23 is a work flow diagram from the outside counsel's perspective, of the expense invoicing process;

FIG. 24 illustrates a work flow diagram of the exception request process from the perspective of outside counsel;

FIG. 25 illustrates the exception request process from the perspective of corporate counsel;

FIG. 26 is a screen output of the litigation cost management system from outside counsel's perspective, showing the exception that has been requested;

FIG. 27 illustrates a screen output from the litigation cost management system from inside counsel's perspective, showing the exception requested;

FIG. 28 illustrates one type of statistical report that the present cost management system can generate; and

FIG. 29 illustrates the cost management system being used in the cloud.

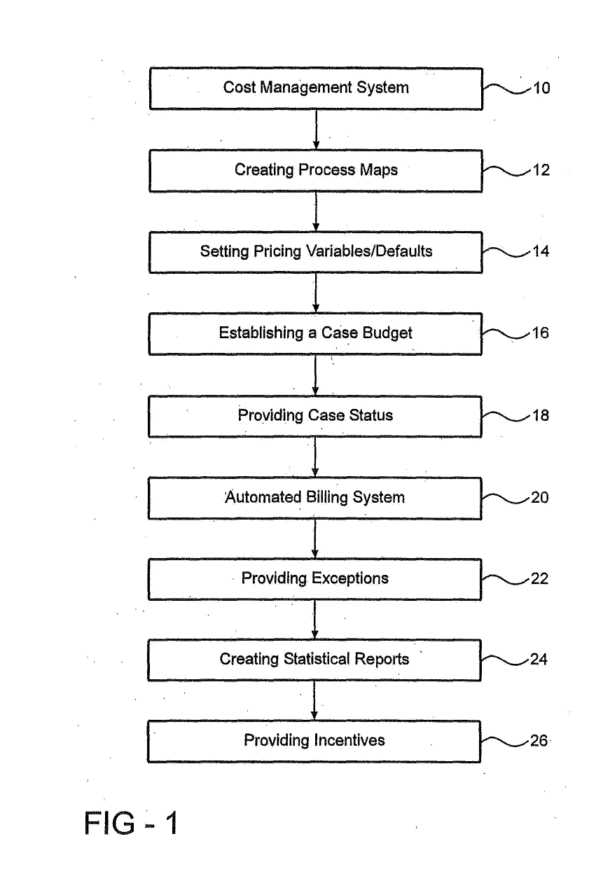

### DETAILED DESCRIPTION OF THE PREFERRED EMBODIMENTS

The Legal Cost Management System 10 uses a computer such as a pc, tablet, smart phone, or the like and allows corporate counsel to communicate through the internet, cloud, etc., with outside counsel. The Management System 10 operates using preferably eight different modules that are interconnected for processing various aspects of the system. The System 10 includes a creating process maps module 12, setting pricing variables and defaults module 14, a project budget module 16, a project status module 18, automated billing system module 20, an exceptions module 22, a statistical reporting module 24, and an incentives module 26. These modules collectively define the Legal Cost Management System which allows corporate counsel to effectively manage legal and its associated costs, when the work is being done. It will be appreciated that the number of modules can vary, without departing from the present invention.

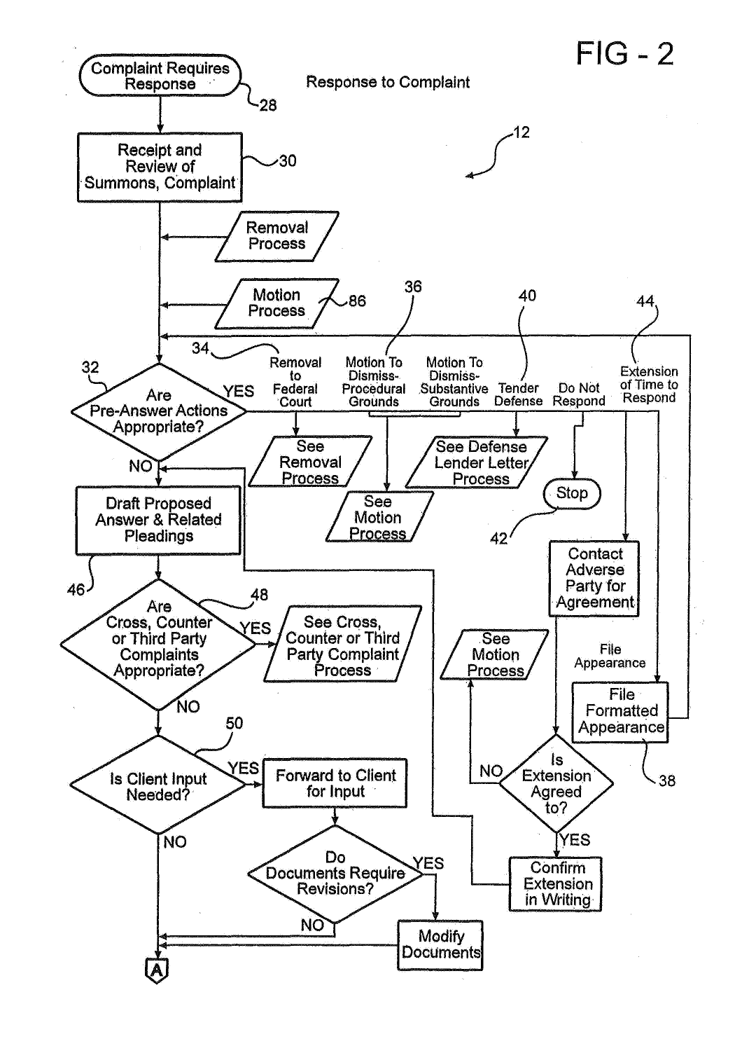

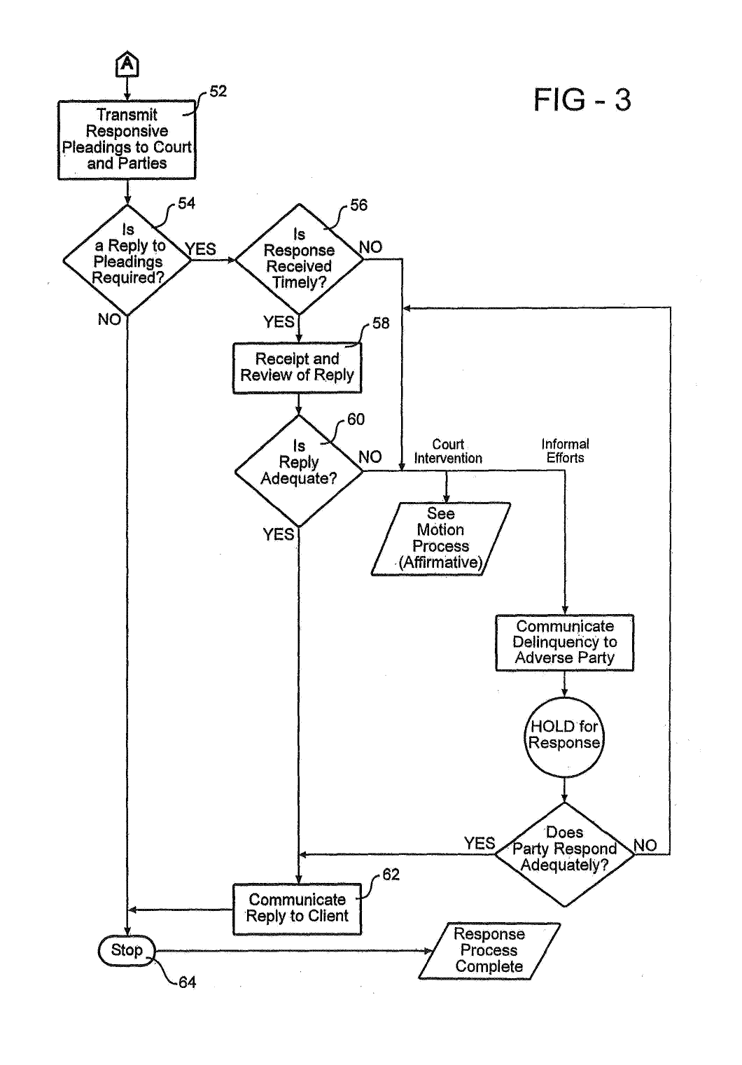

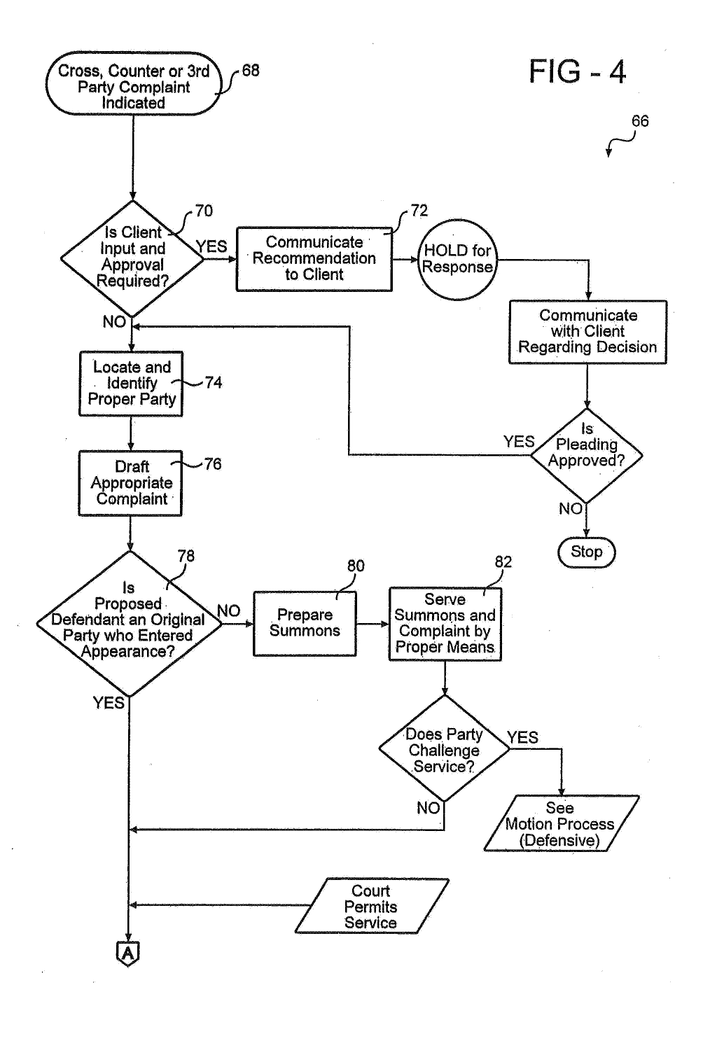

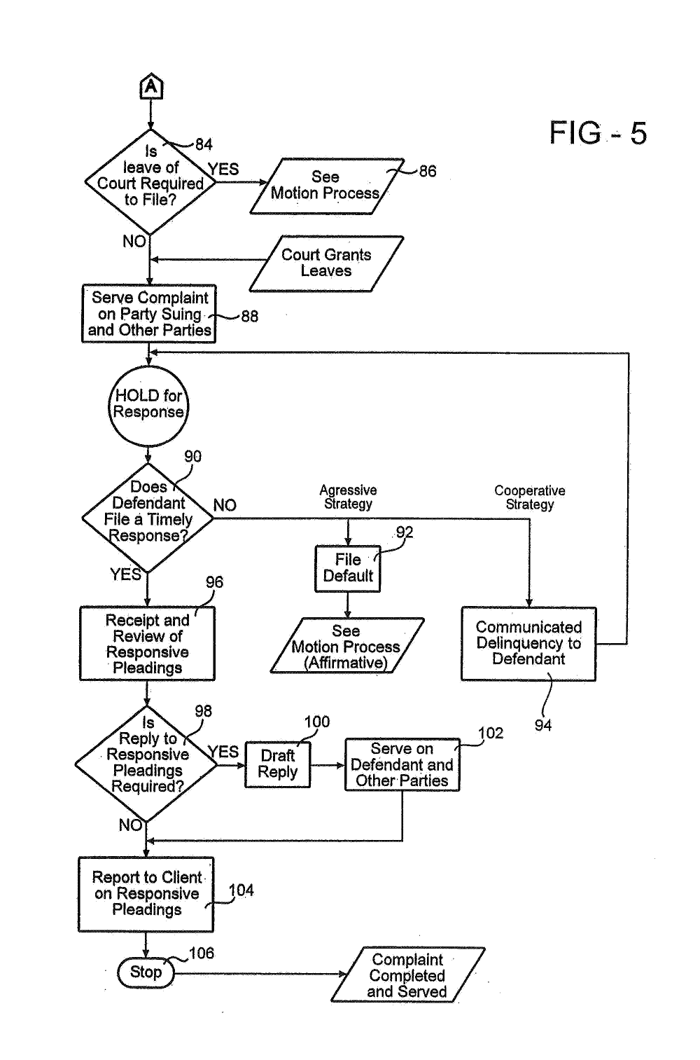

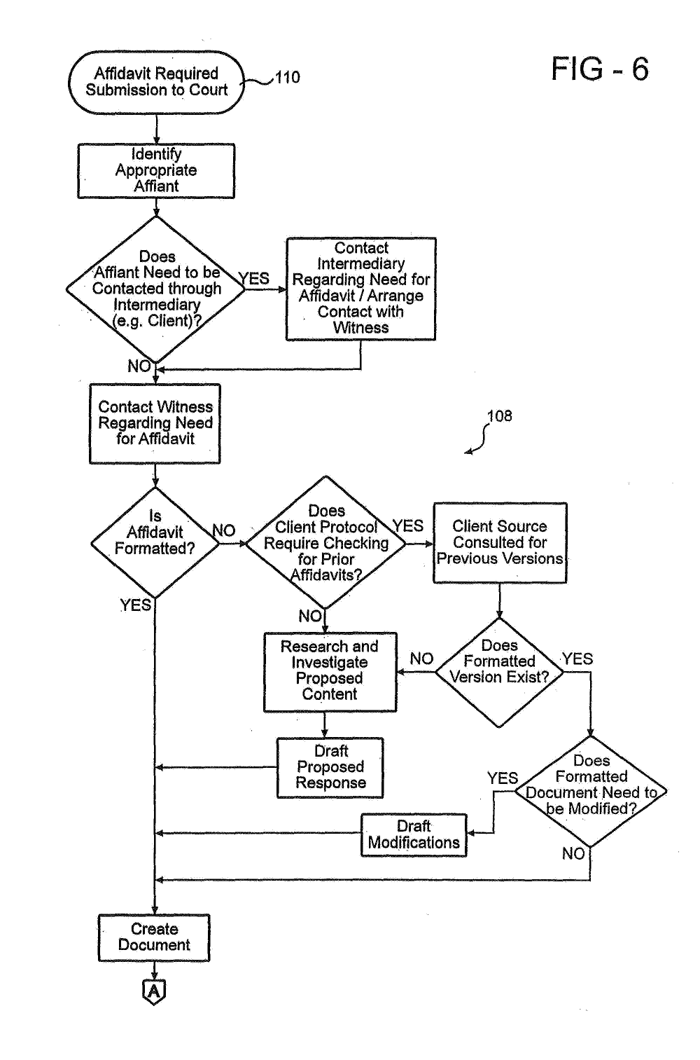

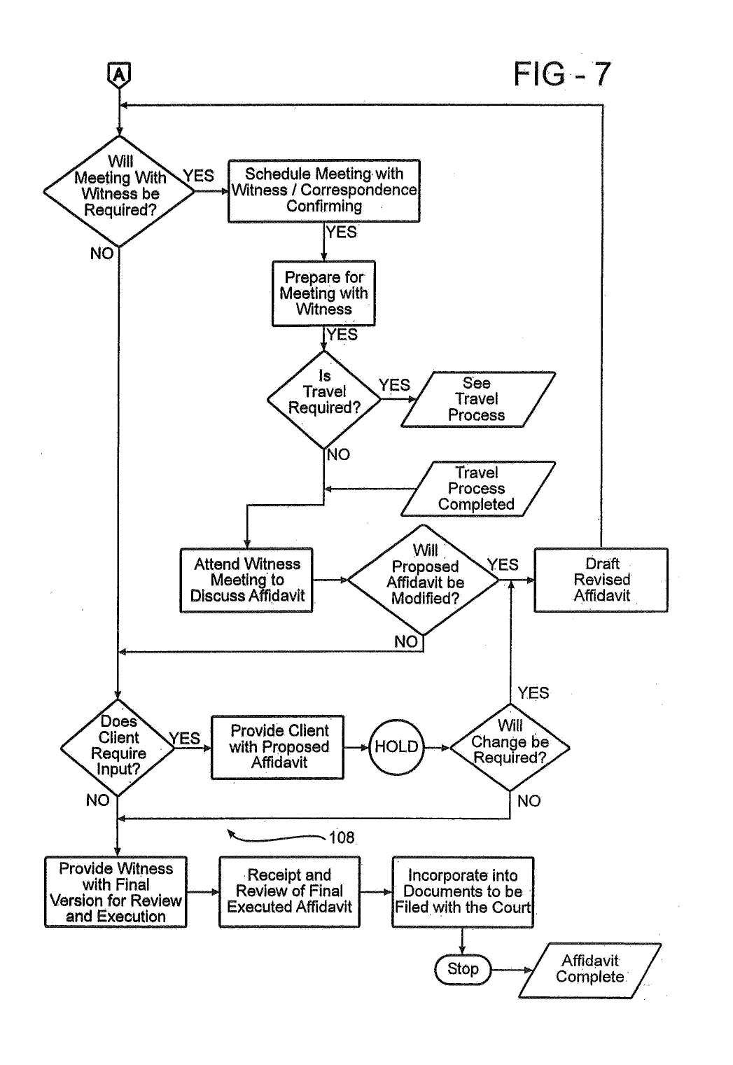

For discussion purposes, the process of managing litigation costs will be described in detail. It will be appreciated that the system 10 can be used in other practice areas such as, but not limited to, administrative and regulatory, banking and financial services, bankruptcy, restructuring, creditors' rights, construction, corporate, employee benefits, energy, environmental, estate planning, employment, sports, media, merger, municipal, family, educational, securities, patent and taxation. The process maps module 12 includes over 30 different maps of the legal process. A few of these process maps are shown in FIGS. 2-7. The process maps represent the steps involved in a particular task, for example responding to a complaint as shown in FIGS. 2 and 3, or preparing a cross-complaint as shown in FIGS. 4 and 5 or the steps for preparing an affidavit as shown in FIGS. 6 and 7. The present system 10 has in it a map of every task of the litigation process and they are placed in a database where they can be called upon at the outset of the case by corporate counsel. Each task has a value assigned to it so that a budget can be created. The present invention includes the following process maps that are available to corporate counsel which are utilized for budgeting and cost management purposes.

(Commencement of Actions/Pleadings).

1. Responsive Pleadings and Third Party Practice.

2. Federal Court Removal Process.

3. Cross, Counter and/or Third Party Complaint.

(Motion Practice).

4. Motion Practice (Affirmative).

5. Motion Practice (Defensive).

(Discovery Directed to Other Parties).

6. Interrogatories (Affirmative).

7. Depositions By Oral Testimony.

8. Depositions On Written Questions.

9. Requests For Production.

10. Requests To Admit.

11. Requests For Examination Of Third Party Or Premises.

12. Compelling Production Of Documents And Things From Non-Parties.

13. Meeting With Witness Who Is Not An Expert Or The Client.

(Discovery Directed to Client).

14. Interrogatories.

15. Depositions By Oral Testimony.

16. Depositions On Written Questions.

17. Request For Production Of Documents And Things.

18. Requests To Admit.

(Investigation).

19. Research Technical And Background Information.

20. Meeting With Client And Witnesses.

21. On-Site Inspection Off Premises.

(Other Activities).

22. Offer Of Judgment (Affirmative).

23. Offer Of Judgment (Defensive).

24. Drafting Affidavit.

25. Evidentiary Hearing.

26. Pretrial And Settlement Conferences.

27. Expert Witnesses.

28. Witness Preparation.

(Resolution Efforts).

29. Mediation/Facilitation Efforts.

The Cost Management System 10 is capable of utilizing yet other process maps that could be added to the System. These process maps are in the system 10 but can be modified by corporate counsel in order to tailor fit the expected process for a particular piece of litigation. Thus, the System is flexible in that it can be modified in order to manage cost of any type of litigation.

FIG. 2 depicts a process map 12 for the steps involved with, outside counsel responding to a Complaint 28. The first step is to receive and review 30 the complaint and ascertain whether pre-answer actions 32 are appropriate. If action is necessary, then actions such as removal to Federal Court 34, filing a motion to dismiss 36, can take place. Counsel can also file an appearance 38, or, if insurance or a third party may be responsible, the defendant could tender a defense 40 at which time future work would stop 42 if the defense is accepted. A party may also obtain an extension of time 44 in order to proceed onward with the case.

FIG. 3 illustrates yet additional steps for responding to the complaint which includes transmitting 52 the responsive pleading to the court. Once that is done, a determination 54 must be made as to whether a reply to the pleading is required, and, if so, a decision 56 is made as to whether a response is timely received. If it has been timely received, then it is reviewed 58 and a determination 60 is made as to whether the reply is adequate. If it is adequate, then it is communicated 62 to the client. Thereafter, the process for responding to the complaint is stopped 64. No further action is taken on this process map. Thereafter, the billing attorney in charge of this customer can go to the billing module 20 and click send the invoice which will automatically invoice corporate counsel for this work that has been completed. It will be appreciated that the point and click process can be done at any pre-described task segment within each given process.

FIGS. 4 and 5 illustrate a process map 66 for preparing a cross-complaint, counter-complaint or third-party complaint 68. First a decision 70 is made as to whether client input is necessary and if so, the client is informed 72. If client input is not required, then it is necessary to locate and identify the proper party 74, draft the appropriate complaint 76 and then a decision 78 must be made as to whether the proposed defendant is an original party. If not, then a summons 80 must be made and served 82. If the proposed defendant is an original party, then a decision 84 as to whether leave of court is made, and, if so, then the motion practice module 86 is selected. If leave of court is not required, then the complaint is served 88 and the parties wait to determine whether defendant files a timely response 90. If the defendant does not file a timely response, then a default is filed 92 or communication 94 is made with the opponent. However, if the answer is received 96, then a decision 98 is made as to whether any responsive pleadings must be drafted 100 and served 102 on the defendant or the other parties. However, if no responsive pleading is required, then the status is reported 104 to the client where this process is then completed and stopped 106. This summarizes the individual tasks that are encountered when preparing, filing and processing a cross-complaint. Once this work is done, the billing system module 20 can be accessed by the billing attorney, and an invoice can automatically be generated and sent electronically to corporate counsel, to his accounting department, through the internet or some other electronic means. The appropriate personnel can bill completed segments as the work is finished without waiting for the entire responsive pleading practice being completed.

FIGS. 6 and 7 illustrate the process map 108 for creating an affidavit 110. The individual tasks are set out in the flow charts depicted in FIGS. 6 and 7. Each individual action task has a pricing value with a range associated with it. During the budgeting process, these values are input or activated by corporate counsel in order to generate a proposed budget. It will be appreciated that similar types of process maps are created for each of the other above-mentioned litigation processes. The process maps illustrated in FIGS. 2-7 are merely representative of the process maps utilized by the system 10 which would be of similar logic as the one disclosed herein, but specifically tailored for their particular litigation process.

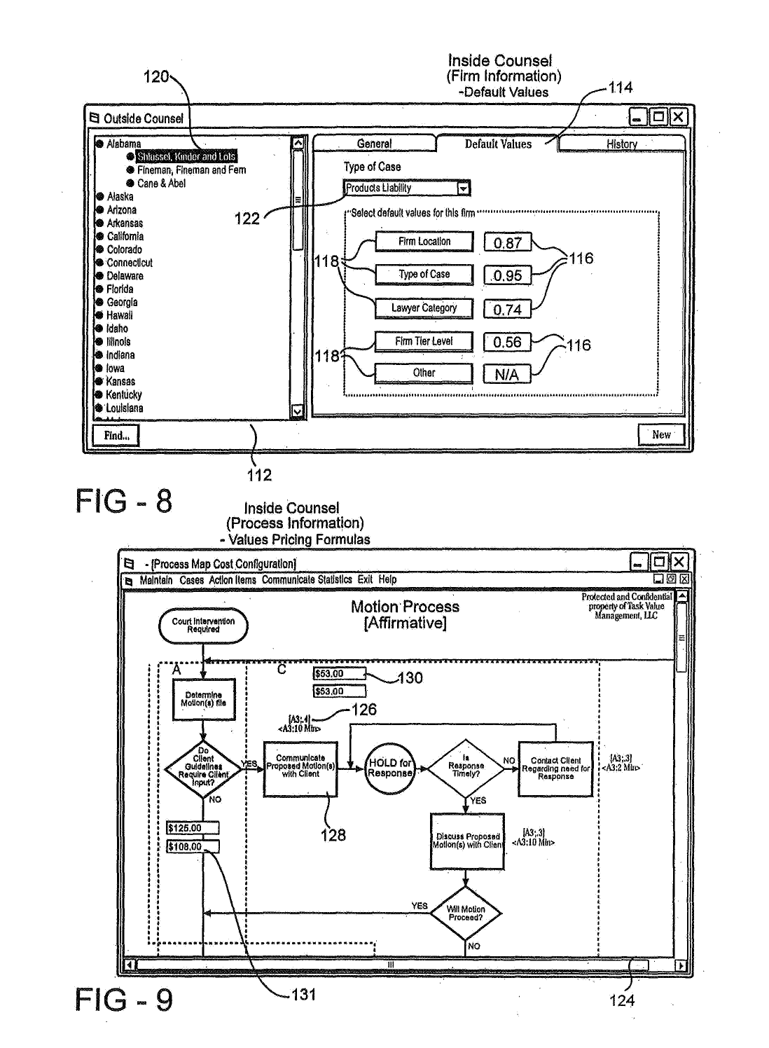

FIGS. 8 and 9 depict screens from the setting pricing variables and defaults module 14 of the cost management system 10. FIG. 9 shows the baseline of the values in the system 10. The formula used to establish the baseline values could consider factors such as task description, level of expertise, normal hourly rates, time required to complete a certain task and the value of the task. These baseline values can be changed by adjusting the default values, which is done by going to screen 112 of FIG. 8. The default values shown in FIG. 8 can be preset for a particular law firm once it is in the system. A formula can be used to compute the default values once a certain firm and type of case is selected. These factors allow for adjustment of the base line numbers in order to generate an accurate budget. Alternatively, individual tasks can be given a set price and they are placed into task value segments which allow for discrete billing. The defaulting values that appear once a firm is selected can be modified by corporate counsel, which adds flexibility to the system.

From the user's perspective, the management system 10 has windows that only corporate counsel can see and windows that outside counsel can see. FIGS. 8 and 9 illustrate screen outputs from the pricing variable/defaults module 14 that corporate counsel will see when it enters the case information into the system. With respect to FIG. 8, the inside counsel will see a screen 112 with a general tab, a default values tab and a history tab. When the default value tab 114 is selected, values 116 are already preset in the firm location, type of case, lawyer category, firm tier level and other categories 118. These values can be changed by corporate counsel if the defaults are not acceptable. These values are based upon inside counsel selecting a particular firm 120 in the pull down menu on the left hand side of the screen. As law firms are added to the system 10, the database will include the information necessary to complete the categories 118. The purpose of the categories 118 is to take into consideration standard features that are inherent with the type of case 122 and venue. The default values are factored in when creating the case budget. These default values 114 can be modified by corporate counsel. These types of parameters assist corporate counsel in standardizing the system 10 and to maintain continuity in the budgeting process.

The firm location category takes into consideration whether the case is pending in New York, Omaha, or some other city. The higher the value, the more likely it is pending in a big city such as New York. The type of case category 122 places a higher value on intellectual property cases and a lower value on cases such as workers' compensation. The other categories, such as lawyer category, firm tier and other, provide additional factors for corporate counsel to take into consideration when creating a budget.

FIG. 9 illustrates a screen shot 124 of the process map for filing a motion with the value pricing baseline data 126 illustrated for each task to be completed in that process. This is one of the aspects of the present invention as it allows corporate counsel to specifically price each particular task 128 in the process map. Here, ten minutes is allotted for the task communicating proposed motion with client 128 and a specified attorney is designated for this task. The default values 114 are already preset, and a $53 amount 130 appears on screen 124 so that corporate counsel can see the actual targeted cost of that particular task. In this instance, there is no variance as $53 is the set amount. Alternatively, a variance 131 can be provided by corporate counsel. Thus, the system 10 is flexible in its pricing structure. Pricing baseline data 126 is provided for each action step that is set out in the process map and collectively are accumulated with all other maps within the system 10 in order to generate a proposed budget. Corporate counsel may go to the screen, change the values that are in the pricing baseline data 126 so as to adjust the value for a given task 128. Corporate counsel sets these formulas or variables for each of the process maps prior to the case budget being submitted to outside counsel. Modifying variables allows the client the flexibility to give ranges to each task. It will be appreciated that at the discretion of inside counsel, no range can be assigned, but instead, a fixed value for each task can be input.

Each task can have a dollar range 130 associated with it to provide upper and lower control limits for a particular event. As long as outside counsel stays within these control limits, the system 10 can automatically approve any invoice regarding performance of such task. Alternatively, corporate counsel could require everything to be approved. Also, corporate counsel can track where outside counsel performs within this range, so as to compare a particular law firm to other firms. This type of data is generated by the statistical reports module 24.

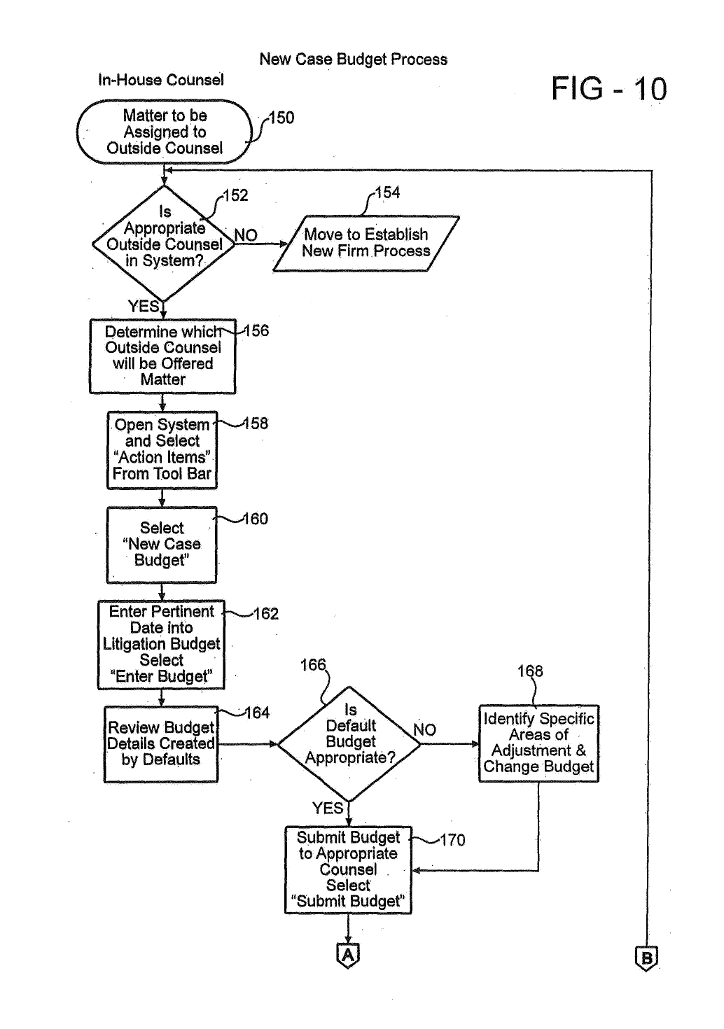

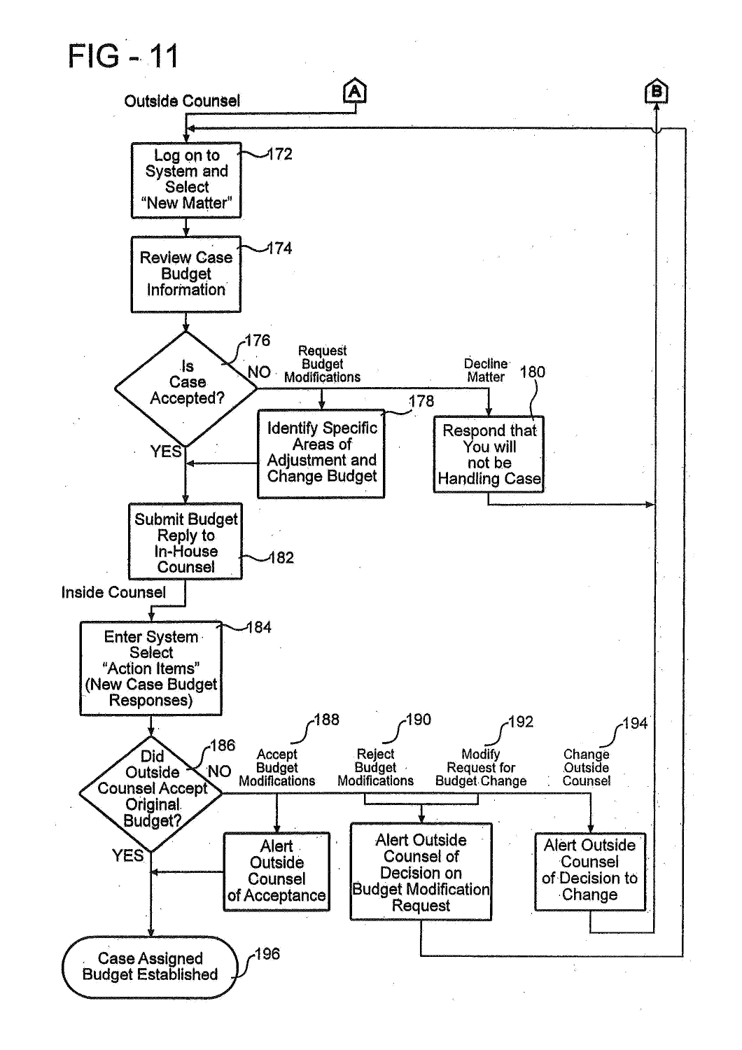

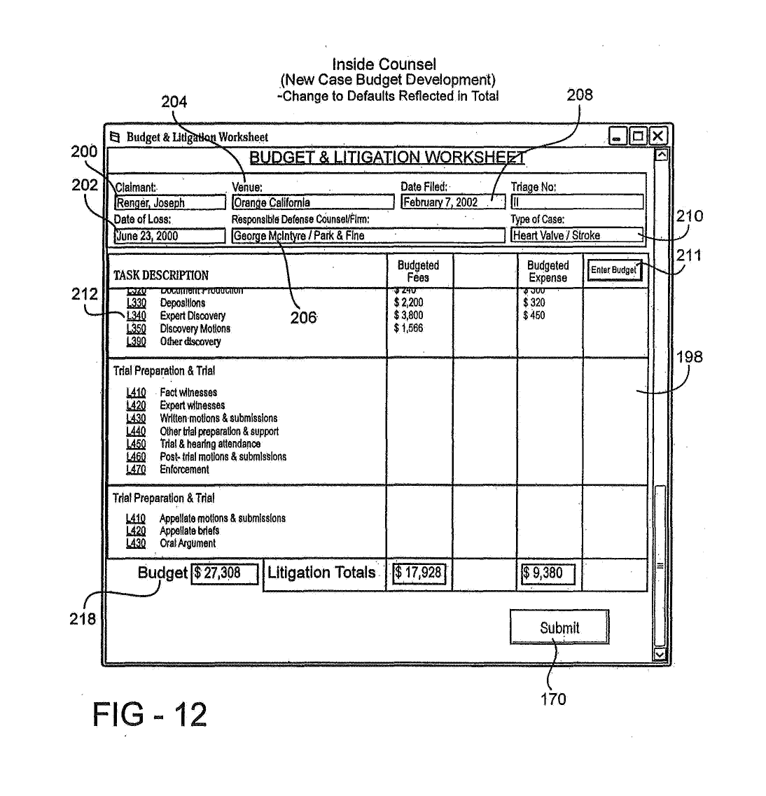

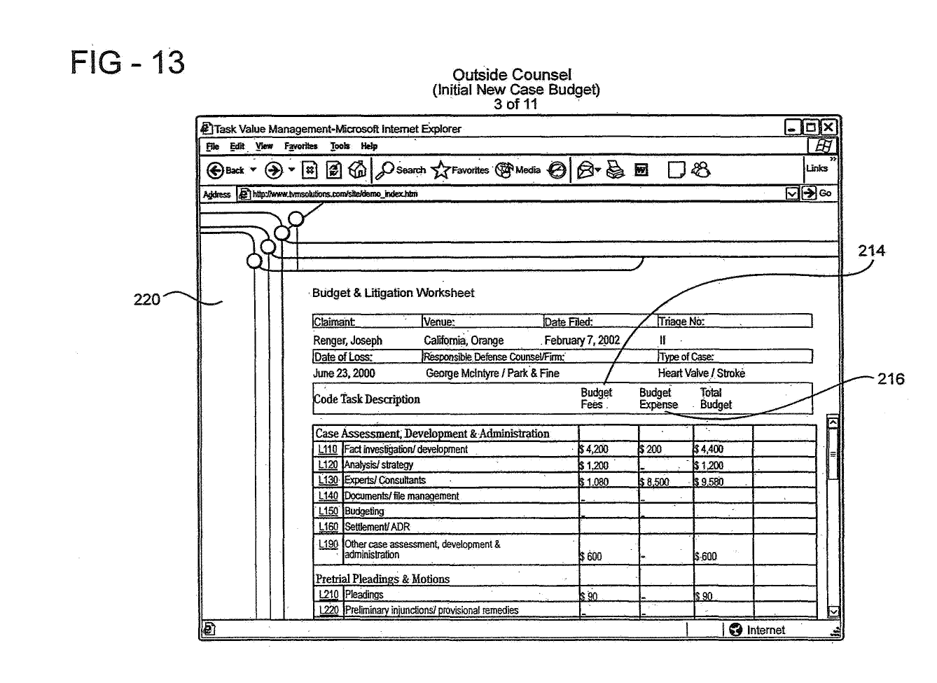

FIGS. 10 and 11 illustrate the steps corporate counsel goes through in order to establish a case budget 16. FIGS. 12 and 13 illustrate a budget litigation worksheet screen that inside and outside counsel use when creating a new case budget. It will be appreciated that this is merely representative of the various screens that either counsel may see.

FIG. 10 illustrates the steps that corporate counsel goes through in order to set up a new case budget. First, in-house counsel ascertains whether the matter is to be sent to outside counsel 150. A decision 152 is made as to whether outside counsel is currently in the system and, if not, it must be placed into the system 154. If they are in the system, then it must be determined 156 which outside counsel to refer the matter to. Once that is done, outside counsel begins the process by starting the cost management software and then clicking on the action items 158 toolbar and selecting a new case budget window 160. Once the window is open, corporate counsel enters pertinent data into the system and then hits the enter budget button 162.

Next, corporate counsel reviews the budget details that are created by the defaults 164 and makes a decision 166 as to whether the budget is appropriate and if it is not, then the budget is changed 168. However, if the default budget is appropriate, then the budget is submitted 170 to outside counsel.

FIG. 11, illustrates the steps associated with outside counsel reviewing the proposed budget. This is accomplished with outside counsel logging on 172 to the system and selecting the new matter button. Outside counsel now reviews 174 the case budget information and ascertains 176 whether it is acceptable. If it is not acceptable, then modifications 178 can occur or the matter can be declined 180 by outside counsel. However, if the case is accepted, then the budget is submitted back to corporate counsel 182.

Inside counsel now goes to the action items tab and clicks on new case budget responses 184. A decision 186 is then made as to whether outside counsel accepts the original budget, and if not, outside counsel may consider alternative actions such as accepting the modified budget 188, or rejecting the budget modifications 190, or modify the request for budget change 192 or to change outside counsel 194. Alternatively, if the original budget is accepted, then the case is assigned 196 and a budget is established.

The above steps set forth in FIGS. 10 and 11 show the entire process of establishing a new case budget. This becomes the roadmap for all future work that is done on this particular case. Exceptions, of course, can be provided and are discussed in the Exceptions module 12.

FIG. 12 illustrates the screen 198 the in-house counsel sees at the step of submitting the budget 170. The budget worksheet identifies in fields the particular name of the plaintiff 200, the date of the purported injury 202, the location of the lawsuit 204, the name of the outside counsel 206 that has been identified in step 156 as the proposed counsel, the date the complaint was filed 208 and the type of case that is at issue 210. It will be appreciated that this screen can have other categories other than those set forth herein. If the type of case has been done before, and the pricing is in the system 10, then the counsel hits the enter budget button 211 and all of the defaults that are stored in the system are used to generate a budget. After it is generated, corporate counsel then may tailor fit the default budget for a particular type of case. To modify the default budget, corporate counsel, for example, may hit a task code 212 that she wants to modify and a screen pops up. The screen, for example, allows for additional tasks to be added which in turn allows the default budget to generate a new budget specifically designed for a particular case.

Columns are provided that describe a task code 212 which provide default descriptions of the work to be selected by outside counsel. Fees and expenses are added to create the proposed budget 218 by in-house counsel. The budget is transmitted to outside counsel by pressing the submit button 170.

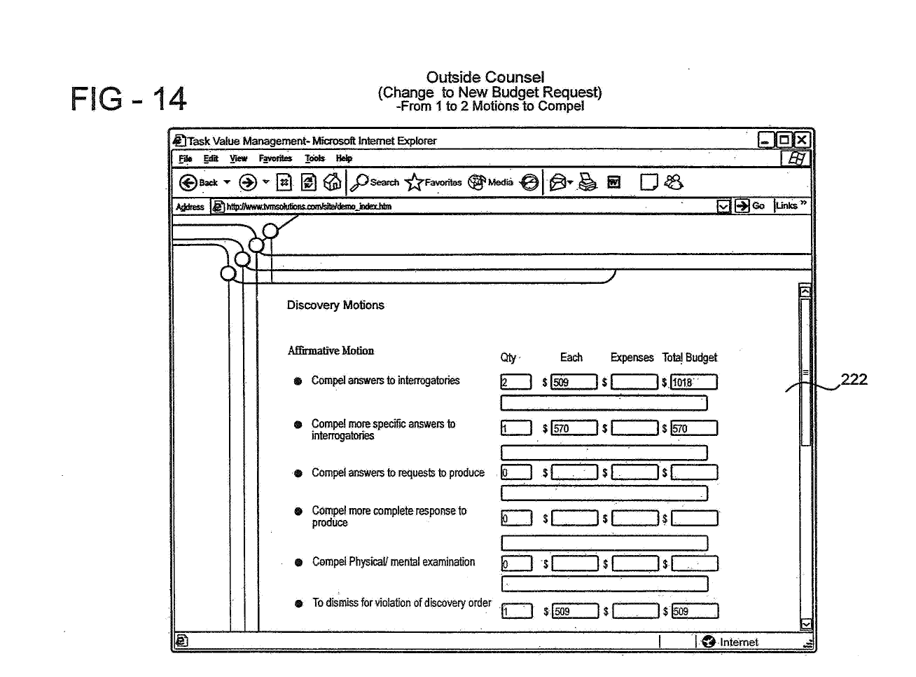

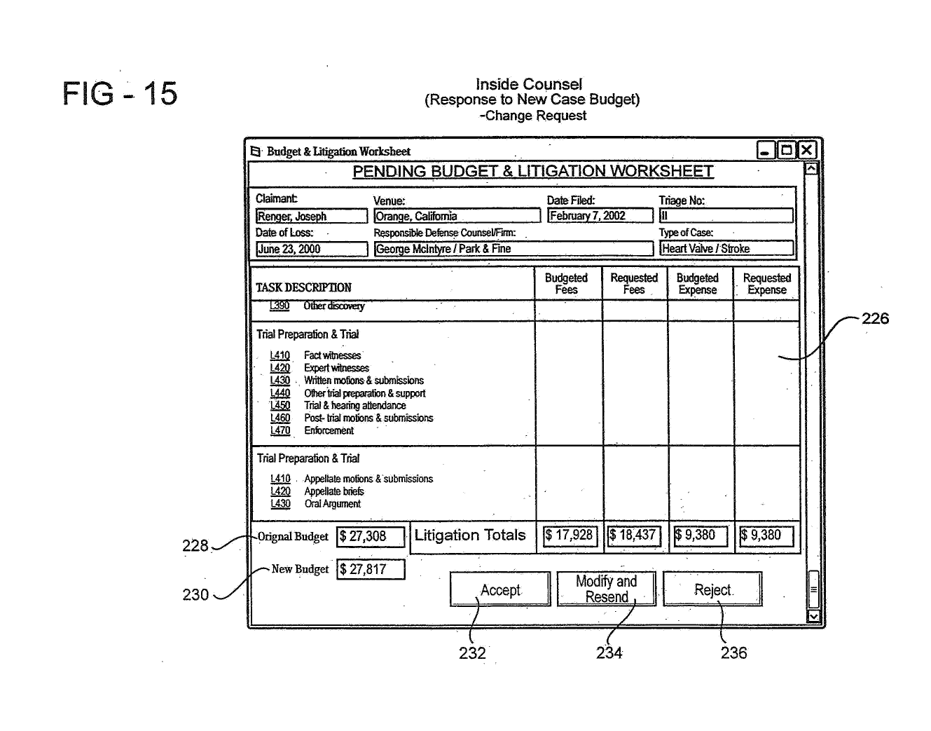

FIG. 13 illustrates the screen 220 seen by outside counsel once the budget has been submitted to him. Outside counsel can accept or reject or revise the budget. If they wish to revise the budget, they go to screen 222 (FIG. 14) and click on a task code, adjust the quantity of the process to be performed and the system 10 changes the pricing once the screen 222 is closed. Next the new budget numbers are reflected on the bottom of the screen 220 of FIG. 13. The submit button is then pressed and inside counsel sees screen 226 of FIG. 15 which shows the changes that were made to the original budget. When this process is completed, corporate counsel closes screen 226, which causes the budget to be finalized.

FIG. 15 illustrates a screen 226 that inside counsel sees once the new proposed budget is sent from outside counsel. The original budget 228 is illustrated next to the new budget 230. Inside counsel can accept 232, modify 234 or reject 236 the budget and resend it to outside counsel. The budget can be adjusted by going back into a screen similar to that shown in FIG. 14. After the adjustments are made, the revised budget can be resent to outside counsel.

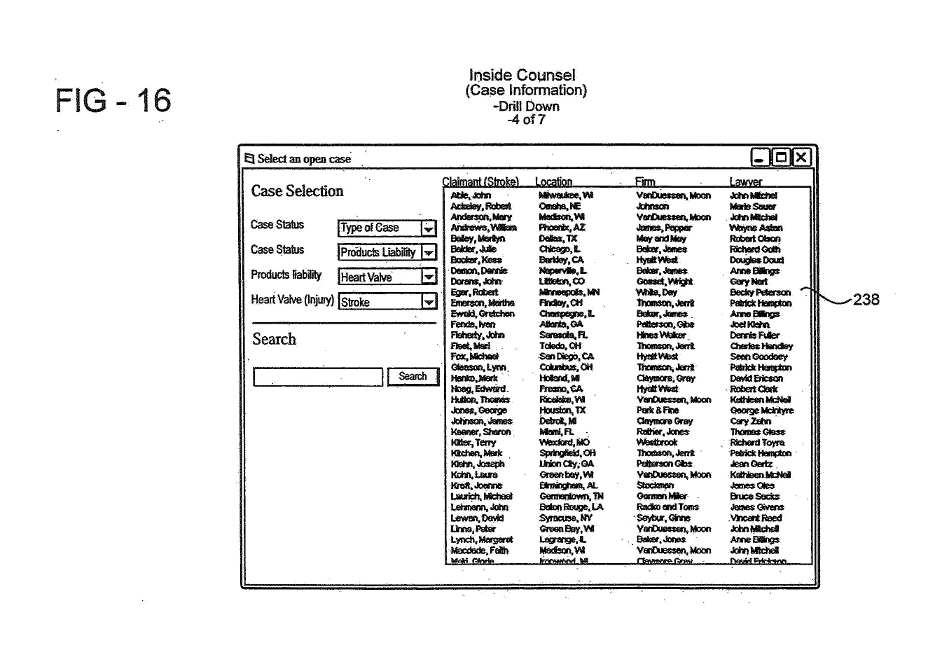

The case status module 18 of the system 10 provides various screens 238 for providing information to corporate counsel. FIG. 16 illustrates a screen 238 that corporate counsel reviews in order to check the status of an existing case within the system 10. From the screen 238, counsel can select specific cases in order to obtain real time information on any particular case the company is monitoring, as long as the data for that case has been put into the system 10. The cases illustrated in FIG. 16 are merely exemplary.

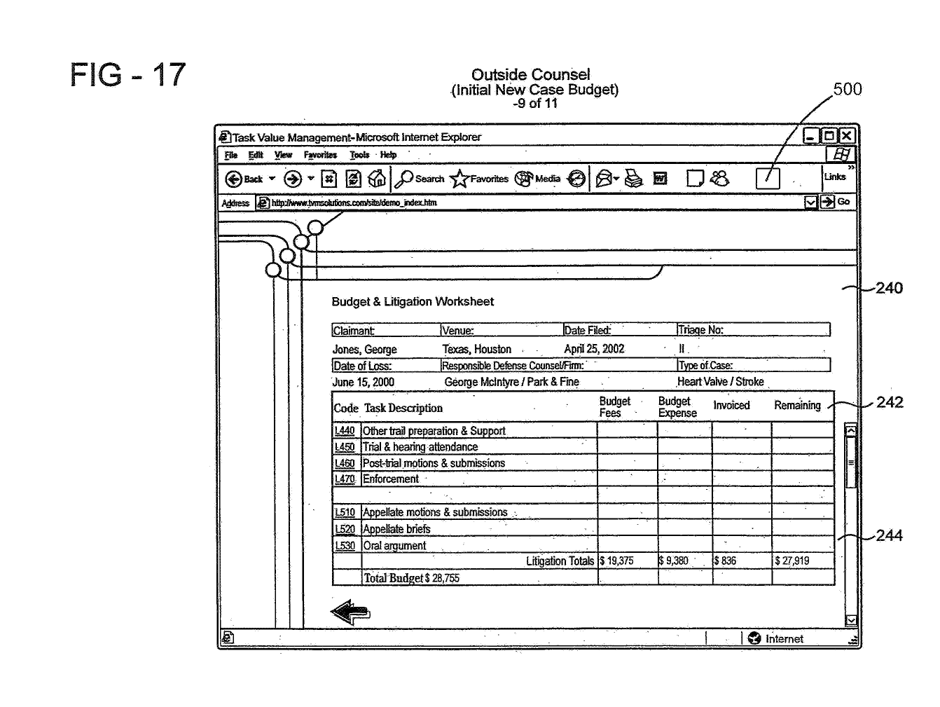

FIG. 17 illustrates a screen output 240 that outside counsel sees which shows the current status of a particular case. From the screen 240, outside counsel can ascertain the amount remaining in the budget 242 and compare that to the original budget. This is presented in a form of a budget and litigation worksheet 244 which summarizes all expenses and fees to date for that particular case.

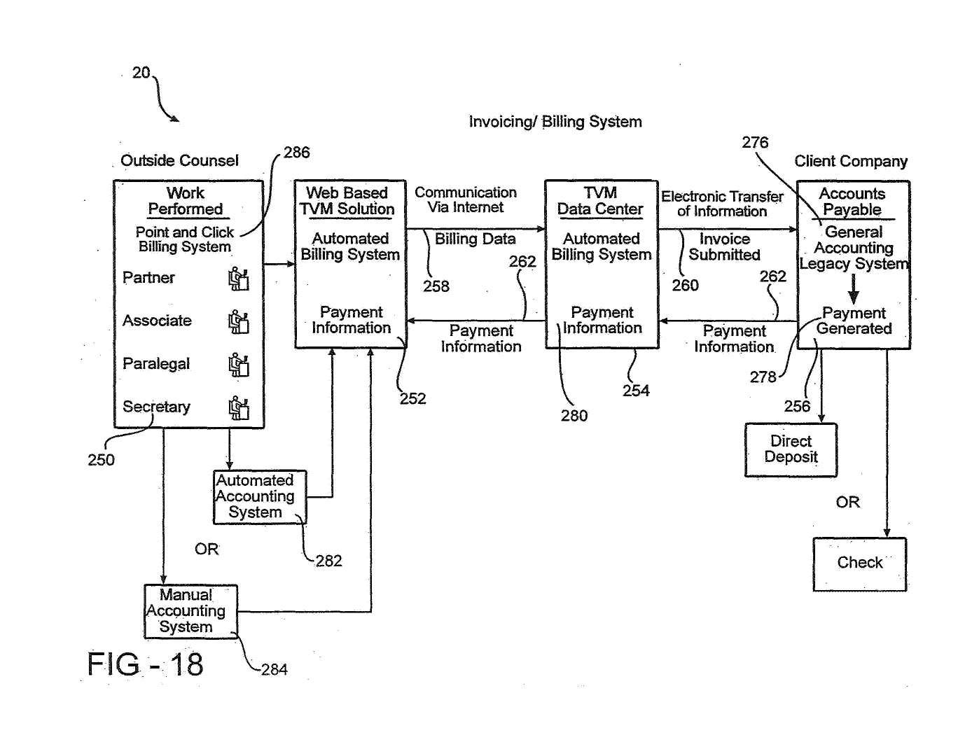

FIG. 18 represents the billing system module 20 which is an automated process that minimizes steps outside counsel must take in order to get paid. The billing system module 20 includes a work performed segment 250 and a web based segment 252, a data center 254, and an accounts payable segment 256. The segments are connected and allow the free transfer of information, such as billing data 258, submission of invoices 260 and payment information 262.

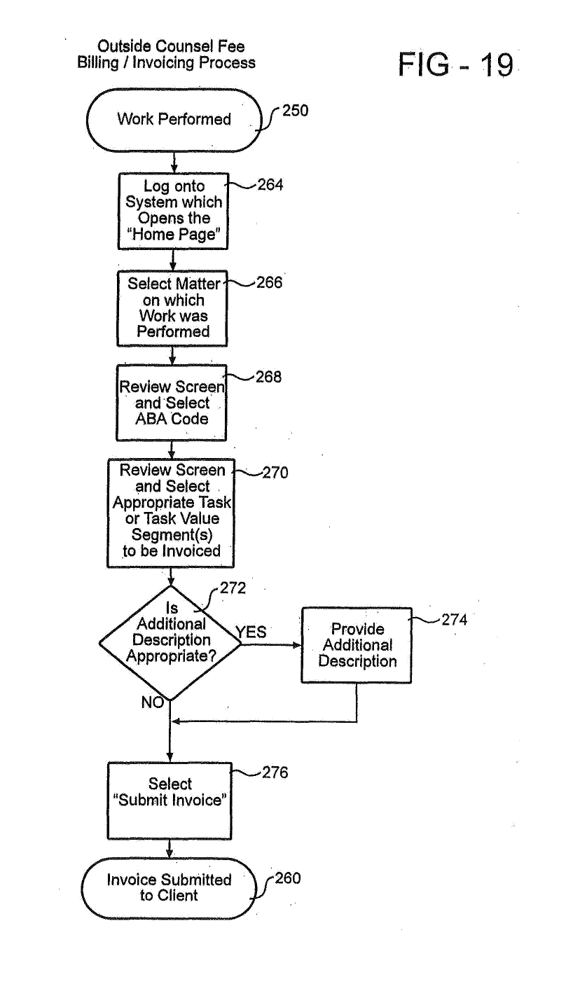

FIG. 19 is a flow diagram showing the steps outside counsel goes through in order to submit invoices to corporate counsel. To start the billing the work performed segment 250, first, the attorney logs into the system and opens the home page 264. Once opened, the attorney selects the matter 266 on which work has been performed, reviews the screen and selects the code 268 for the work that has been completed. The appropriate task segment, or segments, is then selected 270, within a particular code and that represents work that was done on a particular process such as a motion, deposition, etc. Next, the attorney must ascertain whether an additional description 272 is required and if so, an additional description is provided 274. If no additional description is required, then the attorney hits the submit invoice tab 276 and the invoice is then submitted to the client 260. The invoice then goes to the corporation's general accounting system 276 where payment is generated 278 by either direct deposit, or by check. Information regarding the payment 262 is transmitted back through the data center 254 where it is processed and historical payment information 280 is generated. That payment information 266 is then sent back to the web segment 252 for distribution to the in-house counsel's automated accounting system 282 or a manual accounting system 284. Thus, outside counsel's accounting system 282 is capable of communicating via internet or some other electronic transfer means, for example satellite, to the company's accounting system 276. Thus, real time payment information 262 flows between the company and outside counsel, allowing either to have accurate information on payment status.

The data center 254 is operable to house all of the data for a particular client/company and acts as the hub for every law firm in the system 10 to funnel its billing and payment information therethrough. The data center 254 is operable to sort and generate the statistical reports for reporting module 24 and becomes a tool for corporate counsel to monitor all costs running through the system 10.

The web segment 252 is the porthole through which a particular law firm transmits its billing data to the company's data center 254, and it receives payment information 262 back from the data center 254. The point and click billing system 286 standardizes the inputting of the work that has been performed by simply clicking on the code as discussed in FIG. 19 and then drilling down to the particular task that has been completed.

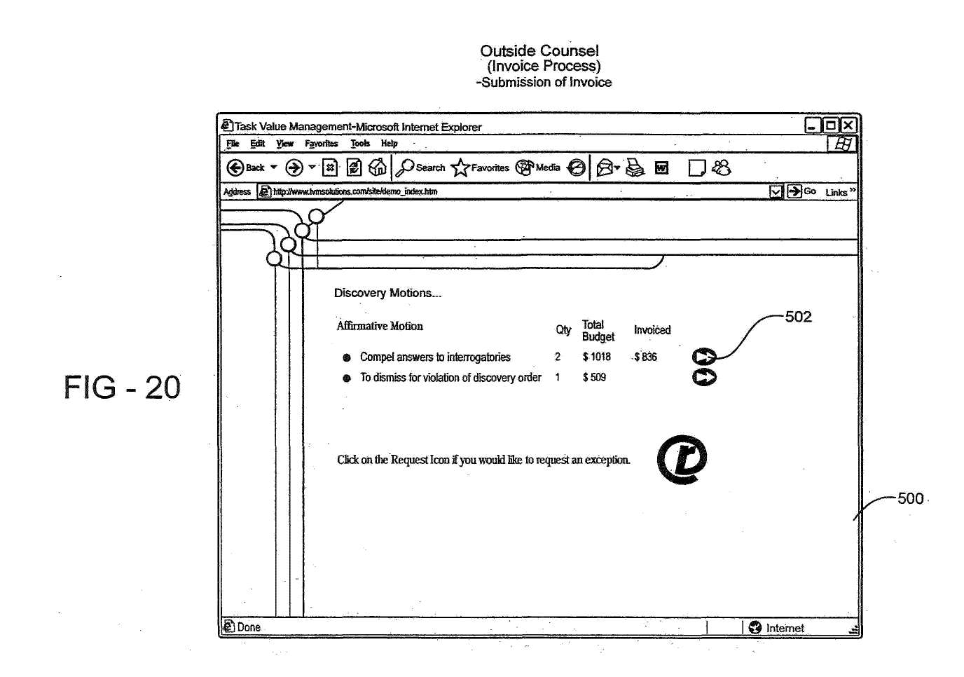

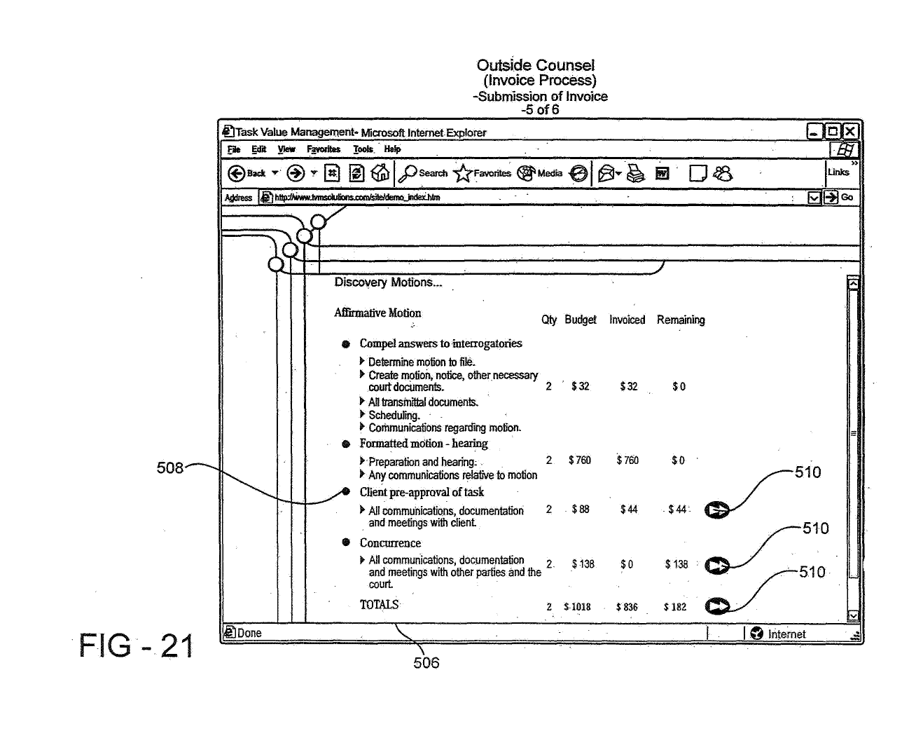

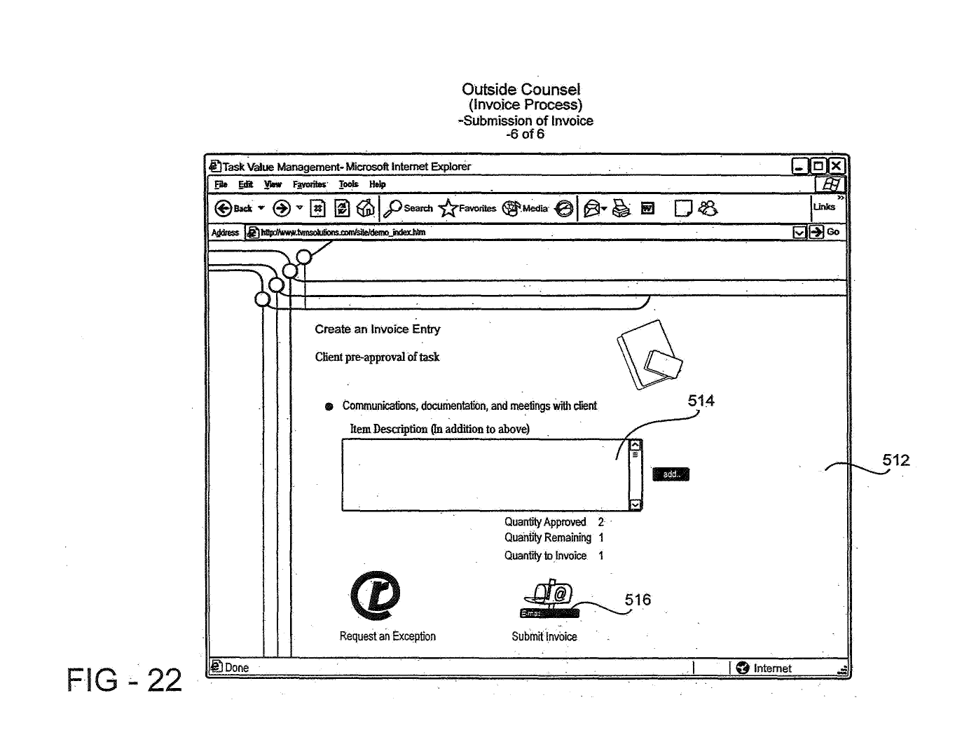

FIG. 20 illustrates a screen 500 that the billing attorney will see when a process has been completed and the task is ready to be billed. Here, arrow 502 is hit which takes counsel to screen 506 of FIG. 21. Then, a specific task 508 that has been completed can be selected and billed by hitting arrow 510 causing screen 512 to appear (FIG. 22). An additional description 514 can be added if desired. Otherwise, submit invoice button 516 is hit causing an invoice to be electronically transmitted as depicted in the FIG. 18 diagram.

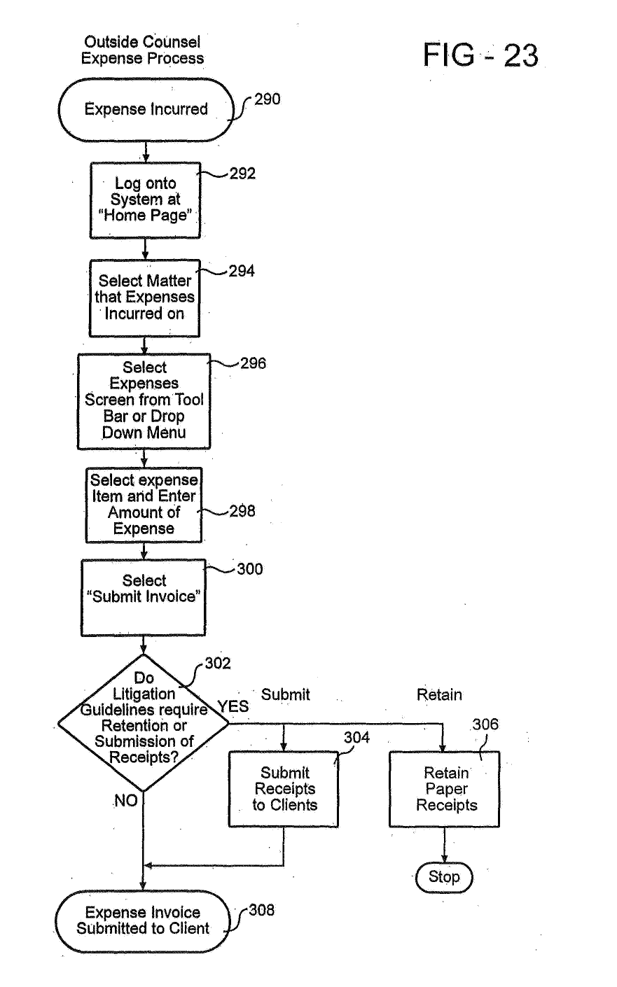

FIG. 23 illustrates a workflow diagram for outside counsel to enter into the system 10, the expenses 290 that have been incurred. First, outside counsel logs onto the system home page 292 and selects the matter that the expense occurred in 294. Next counsel selects the expense screen 296 from the tool bar or from a pull-down menu and selects the expense item 298 and enters the amount of the expense. The submit invoice button 300 is clicked on and then the attorney must make the decision as to whether the litigation guidelines require a receipt 302, and if so, then it will be submitted 304 to counsel or retained 306, depending on the circumstances. If there is no retention policy on receipts then the expense invoice is submitted to the client 308. The expense invoice is processed through the billing system module 20 as set forth in FIG. 18 and the payment is generated 278 as discussed above. The expense information is stored in the data center 254 for later statistical analysis and processing.

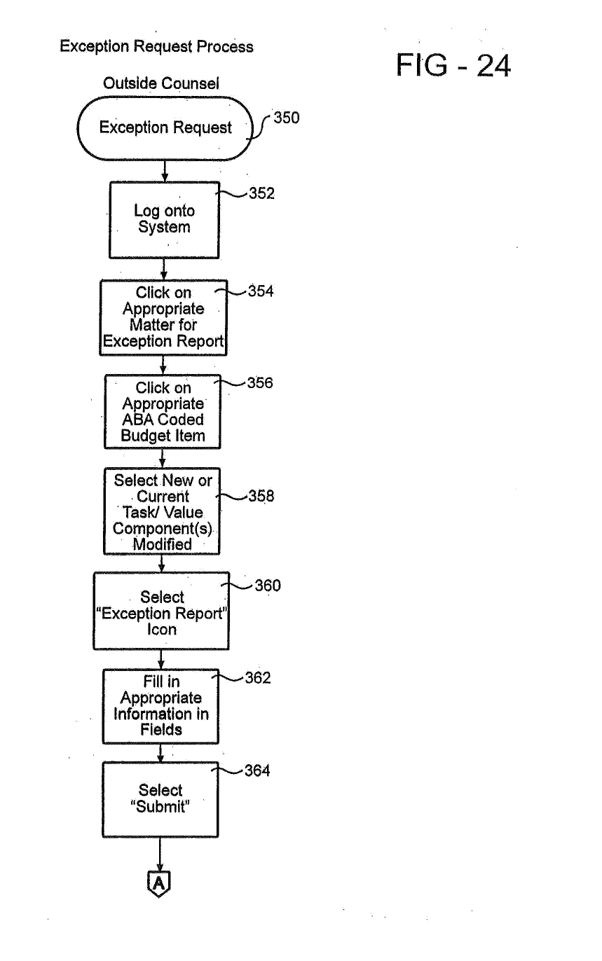

With reference to FIG. 24, the exceptions module 22 provides for modification of the existing case budget when new tasks are to be performed. For example, an unplanned event during the course of litigation may arise as a result of the court sua sponte issuing an order. In such an instance, an exception request 350 would be generated and outside counsel would log on to the system 352, click on the appropriate matter for the exception 354, click the appropriate coded budget item 356 and select a new task 358. It will be appreciated that the value of a task can be modified, for example if it adds an increase in value to a task that is already in the system. Counsel then selects the exception report icon 360 and fills in 362 the appropriate information in the fields and then selects the submit tab 364 for sending the exception request to inside counsel.

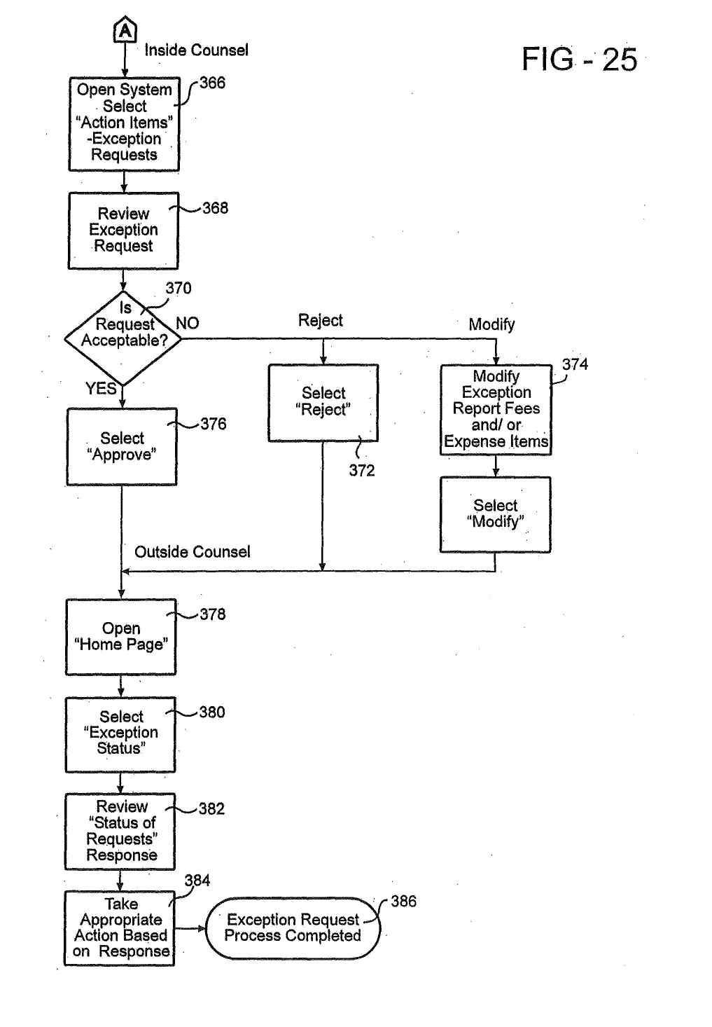

FIG. 25 illustrates the steps for processing the exception request from corporate counsel's viewpoint. Here corporate counsel opens the system 10 and selects the action items exception request button 366. The request is reviewed 368 and corporate counsel must now consider 370 as to whether to reject 372 or to modify 374 the request. However, if counsel approves the request then the approve button 376 is selected sending a communication back to outside counsel of her decision. Outside counsel then opens the home page 378 and selects the exception status tab 380 and reviews 382 the status of the request. Outside counsel then takes the appropriate action based upon the response 384 and completes the task, if authorized. The exception request process is now completed 386 and can now be billed utilizing the billing module 20 as discussed above. It will be appreciated that corporate counsel may create an automatic cost approval range and as long as outside counsel's request falls within that range, then the request can be automatically approved.

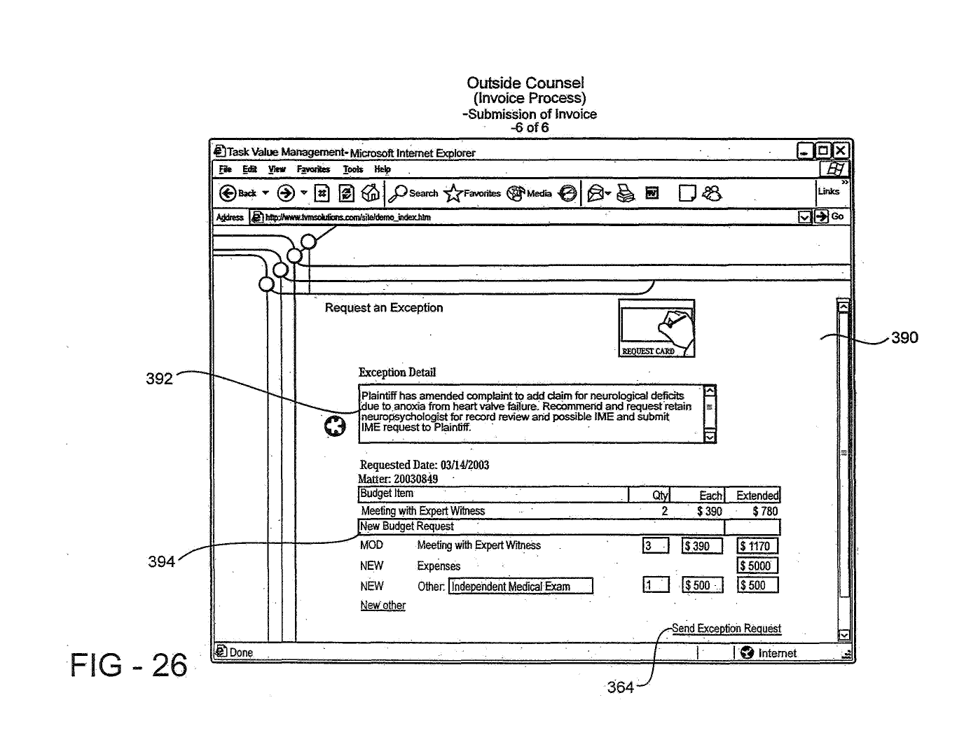

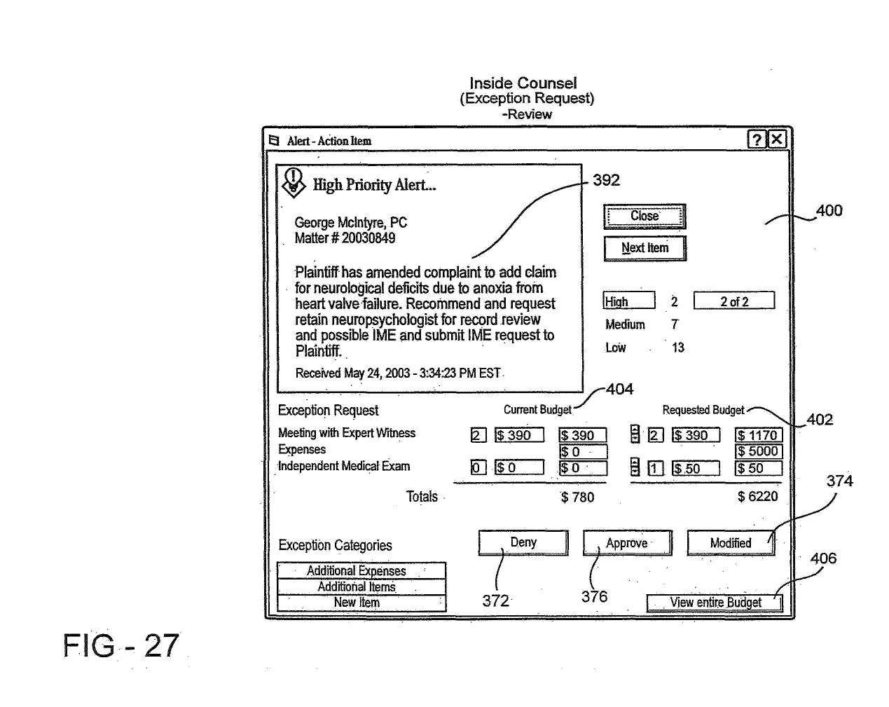

FIGS. 26 and 27 illustrate screen outputs of what outside and inside counsel review when going through the exception request process as outlined in FIGS. 24 and 25. Specifically, FIG. 26 is a screen output 390, from the perspective of outside counsel, which allows outside counsel to describe the exception in detail 392 and provide a new budget request 394. In this instance, the new budget request asks for two meetings with an expert witness, an expense of $5,000 for the expert witness, and an independent medical exam expense of $500. Once outside counsel has completed inputting the data in screen 390, the send button 364 is hit which in turn sends a request to corporate counsel.

FIG. 27 depicts the screen 400 inside counsel sees after an exception request is submitted. This is also shown as review exception request 368 in the FIG. 25 diagram. Inside counsel can now read outside counsel's narrative 392 of what has caused the exception and the recommended course of action. The cost of the new task is set out under the requested budget section 402 and it is compared to the previously agreed to budget 404. At this time, corporate counsel can deny the request 372, approve the request 376 or modify the request 374. The screen 400 also allows corporate counsel to review the entire budget 406 or close the window or move to the next item.

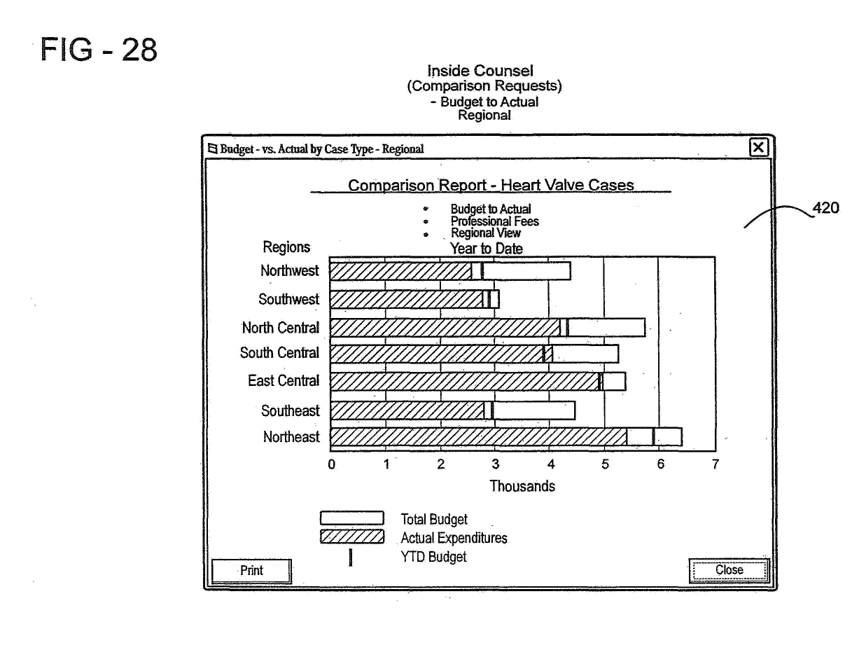

The statistical reporting module 24 is a tool used by corporate counsel in order to compare requests, current budget, and numerous other information that is stored in the date center 254. FIG. 28 illustrates one type of physical data output by a screen 420 showing a comparison report in heart valve cases throughout the various regions of the United States. The year to date budget amount is shown compared to actual expenditures. This allows corporate counsel to assess, at any given time, the costs in a particular type of case that is a heart valve case, throughout the United States.

It will be appreciated that numerous other reports can be generated. This is accomplished by clicking on a statistics tool bar and clicking on either standard reports or custom reports. Some of these standard reports include exception requests by region, exception requests that were granted by region, cost of exception requests by region and analysis of certain types of cases by specific law firms in certain regions of the country. Specific law firm data can be prepared to see which attorneys in a law firm are billing the most. A report can even be generated to find out specific fees and costs for a particular task or case. This and numerous other types of standard reports are available in the system 10 for corporate counsel to review.

The incentives module 26 allows corporate counsel to reward law firms that provide exceptional services, for example, a law firm that creates a new strategy for handling a case that will save the company money. Further, counsel can be awarded a bonus when a winning motion is created that successfully terminates the case early. Because the system 10 controls the budget and it can be determined at any time where one is relative to the budget, a bonus can be easily determined. Thus, corporate counsel can reward a law firm for a new innovative approach. It should be appreciated by those skilled in the art that other variations to the preferred embodiments to the present invention, beyond those mentioned above, are possible. Accordingly, it is to be understood that the protection sought and to be afforded hereby should be deemed to extend to the subject matter defined by the Claims below, including all varied equivalents thereof.

An additional feature of the system 10 is that it can calculate and then convert the set rate and value-based fees that are tracked by the system 10 and provide an hourly rate that in turn can be utilized for reporting on outside counsel's time sheets for outside counsel use. Thus, this provides outside counsel with a metric so that they can ascertain the effective hourly rate for the tasks being performed for a particular project.

The system 10 further has a feature that can capture task codes that may be utilized by the outside counsel and match those task codes to particular documents. The documents then can be matched in order to insure performance by the in house counsel. The system 10 further is operable to once the documents have been matched to specific task codes, transfer those documents to a clients' matter management system, a third party management system and/or a document repository. Transfer of the documents can be made prior to the invoice being submitted. This provides a check in the invoicing system and an alert can be provided to the outside counsel to electronically attach the work product which has been completed. This process insures a timely upload of documents on or around the time period in which a particular task code has been completed. This further assures that outside counsel receives documents in a timely fashion upon completion of each event during the legal process.

Another aspect of the system 10 is to create budgeting templates that match categories and case types. By creating budgeting templates, a budget library can be generated which enables in house counsel to quickly and accurately create a budget for a particular new matter. Once a particular template has been chosen by in house counsel, the system 10 will then calculate the budget including individual tasks that may need to be performed to effectively handle the matter. Those individual tasks are previously selected by virtue of the template having such tasks already in place. FIG. 17 illustrates a budget template button 500 that an operator can interface with in order to perform or use the budget template process or feature.

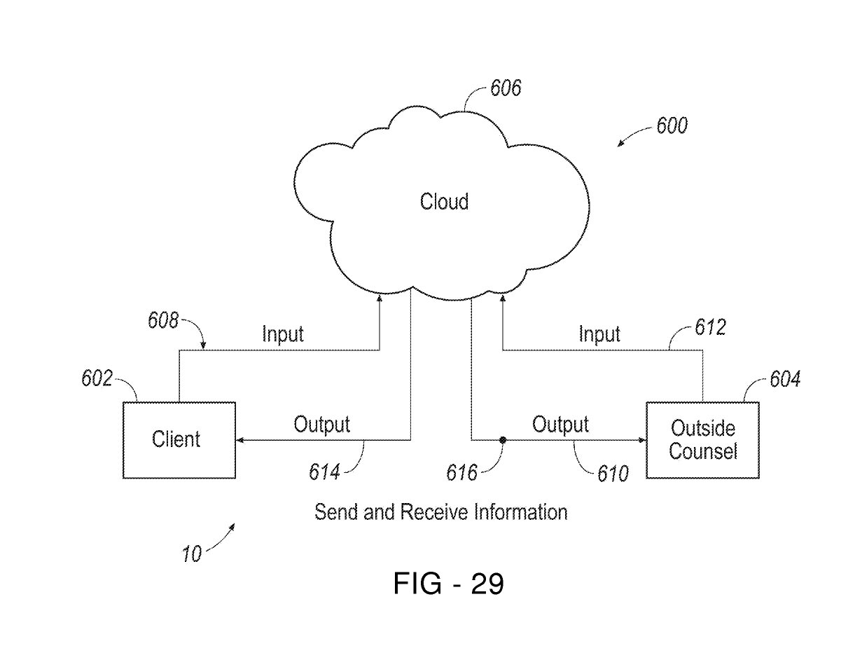

FIG. 29 illustrates the system 10 being used in a cloud computing system 600 where a client 602 interfaces with outside counsel 604 while utilizing the cloud 606. The cloud 606 can be broadly interpreted to include, but not be limited to, a storage capacity for data, information, software, applications, etc. in a secured community. Such information and the like may be also stored on remote servers that are offsite from the client 602 and/or the outside counsel 604 and can be housed by a third party on a private server. The client 602 could be a corporation, an insurance company, or another who has legal tasks that need to be performed. The exchange of information and the like in this cloud computing system 600 can be conducted by a client 602 inputting signals along input path 608 into the cloud 606. Data 616 can be processed, manipulated in the cloud and then directed through the cloud 606 via an output signal path 610 and be directed to outside counsel 604. Outside counsel 604 may then interface with the client 602 by processing an input signal which transmits along path 612 which leads to the cloud 606 whereby information, data, or the like is then transmitted via an output signal path 614 to the client 602. Thus, instead of information 616 being transmitted directly from outside counsel 604 to client 602, the cloud 606 can act as an intermediary. This improved legal service cost management cloud computing system 600 interfaces with a computer, modules that utilize maps, modules for assigning dollar values for tasks, and modules for inputting pre-approved dollar values for each associated task. The cloud based legal cost management system 600 is operable to allow a user to select at least one process map, variables for individual tasks to be done, establish a budget for each task, provide a case status module, and provide a point and click building module. The cloud based system 600 further can be utilized with a computer based cost control management 10 or the like that includes a real time analysis module, a real time budget and cost to complete module, and an exceptions module. It will be further appreciated that the cloud based system 600 can be used with a law firm for managing the cost of legal services including the steps of corporate counsel generating a working budget, the budget being submitted to the law firm through the cloud 606, the budget being considered by the law firm or outside counsel 604, the outside counsel 604 then performing the budgeted legal service, and then the legal firm electronically requesting payment or possible exceptions when the task is outside of the agreed upon budget.

The systems 10 and 600 are operable to operate on a variety of computers, including, but not limited to, smart phones, tablets, desktops, laptops, and other computing devices. It will be appreciated that the cloud computing system 600 can employ other features and methodologies which are within the fair scope of the present invention.

It will be appreciated that the aforementioned process and devices may be modified to have some steps removed, or may have additional steps added, all of which are deemed to be within the spirit of the present invention. Even though the present invention has been described in detail with reference to specific embodiments, it will be appreciated that various modifications and changes can be made to these embodiments without departing from the scope of the present invention as set forth in the claims. Accordingly, the specification and the drawings are to be regarded as an illustrative thought instead of merely a restrictive thought of the scope of the present invention.

What is claimed as new and desired to be protected by Letters Patent of the United States is:

1. A computer based method that allows a client to control and manage the cost of a legal service comprising:
a) selecting at least one process map, each process map consisting of tasks to be done in a legal service;
b) setting variables for each individual task to be done in the legal service;
c) establishing a budget for each task which an outside counsel must follow;
d) providing a case status module with information on how the legal service is proceeding based upon tasks performed to date; and
e) providing a point and click billing module for automatically submitting invoices to the client, the invoices having amounts that equal the value variables for the tasks that have been performed.

2. The method as claimed in claim 1, wherein the legal service is a law suit.

3. The method as claimed in claim 1, further comprising the step of providing statistical reporting to the client.

4. The method claimed in claim 1, wherein the step of selecting process maps includes selecting each anticipated task of the legal service.

5. The method as claimed in claim 1, wherein the step of creating process maps includes identifying each individual task to be performed in the legal service.

6. The method as claimed in claim 1, wherein the step of setting variables includes the client establishing limits for each task to be performed.

7. The method as claimed in claim 1, wherein the step of establishing a budget includes the client generating values for each individual task, the client electronically submitting the budget to outside counsel, and the outside counsel either accepting or rejecting the budget by a submission back to the client.

8. The method as claimed in claim 1, wherein the step of providing a profile status module includes providing a client with current information on status of a particular legal service by transmission of such information over the internet.

9. The method as claimed in claim 1, further comprising the step of cloud computing.

10. The method as claimed in claim 1, wherein the step of providing a point and click billing module includes electronically sending a pre-approved bill to a customer once the task has been completed.

11. The method as claimed in claim 1, wherein the step of providing an exceptions module includes allowing outside counsel to electronically submit requests for approval of new work.

12. The method as claimed in claim 3, wherein the step of providing statistical reporting includes graphically outputting information based on data that is generated by said method.

13. The method as claimed in claim 1, further comprising the step of providing incentives for exceptional performance by outside counsel, electronically notifying outside counsel of the exceptional performance, and compensating outside counsel.

14. The method or claim in claim 1, wherein the legal service is from the group consisting of administrative, bankruptcy, banking, labor, employment, sports, media, merger, municipal, construction, corporate, employee benefits, environmental, estate, family, educational, securities, patent or tax law.

15. The method as in claim 1, further comprising a computer module that calculates and then converts a value based fee variable to an hourly rate variable.

16. The method as in claim 1, further comprising a module that captures task codes that have been completed and matches said task codes to documents generated by counsel performing legal tasks.

17. The method as in claim 1, further comprising the step of providing a budget template.

18. A client controlled legal cost management system comprising:
a computer that is operable to process one or more of the following modules:
a module that maps out in detail legal service variables;
a module for assigning dollar values to each task of the process; and
a module for inputting pre-approved dollar values for each task to be charged by counsel.

19. A computer based cost control and management system for assisting in-house counsel in managing legal costs comprising:
a real time analysis module that is operable to inform in-house counsel of legal cost;
a real time budget and cost to complete module; and
an exception module that is operable to permit outside counsel to request to modify the budget.

20. A system of a law firm and a first party managing the cost of legal services comprising:
a first party generating an actual working budget;
the actual budget being electronically submitted to a law firm by using a computer;
the budget being considered by the law firm;
a legal service be completed based upon an agreed upon budget; and
the law firm electronically requesting exceptions when a task is outside of the agreed upon budget.
